(19) United States
(12) Patent Application Publication
(10) Pub. No.: US 2012/0329017 A1
(43) Pub. Date: Dec. 27, 2012

(54) Method and system of coaching behavior

(76) Inventor: Vu H. Pham, Cerritos, CA (US)

(21) Appl. No.: 13/135,073

(22) Filed: Jun. 23, 2011

(51) Int. Cl. G09B 19/00

(52) U.S. Cl. 434/236

(57) ABSTRACT

A method of coaching behavior by using at least one interactive device, including the steps of: (a) creating a profile through the interactive device, wherein the profile contains at least one type of information, wherein the profile is shown to other peers through a predetermined communication network, (b) setting an objective in relation to the type of information in the interactive device, (c) delivering a push notification to the user through the interactive device, (d) generating a corresponding change to the profile to be shown in the interactive device, wherein when the request is not fulfilled, a negative effect is generated in the profile as the change of the profile, and when the request is substantially fulfilled, a positive effect is generated in the profile as the change of the profile, and (e) receiving feedback from the peers through the communication network in response to the change of the profile.

### BACKGROUND OF THE PRESENT INVENTION

1. Field of Invention

The present invention relates to a behavior coaching and learning reinforcement system and a method thereof, which are capable of assisting a user to accomplish his or her preset objective through peer support and interactive displays.

2. Description of Related Arts

A conventional behavior training system usually comprises an electronic device, such as a computer or a video game machine, which is programmed in such a manner that the user may follow a theme of particular software and achieve a particular objective set by that software. For example, there exist some fitness training games in which a particular objective (such as a user's weight) is set. After that, the user is required to play the game regularly in order to achieve that objective.

There are several disadvantages for conventional behavior training systems. First, the conventional behavior training system, such as a fitness training system, does not allow peer support. The accomplishment of the predetermined objective set by the user may require persistent compliance with what may be a stringent lifestyle on the part of the user, the user may give up performing the required activities after a short period of time. In this situation, the effectiveness of traditional behavior training systems is called into question.

Second, most conventional behavior training systems involve limited applications. For example, the behavior training system may only involve a particular theme (e.g. fitness training) and must be operated by a predetermined machine. For example, a fitness training game can only be run by a video game machine. When the machine is turned off, or the user has no access to that machine, and the training schedule can be ignored by the user. Thus, the effectiveness of the training is severely undermined.

Third, since the operation of the behavior training system depends on a single machine, when the machine is turned off, the user cannot keep track of his or her progress. Moreover, even if the user wants to follow the schedule or a particular pattern of lifestyle, he or she may forget the necessary steps or activities. Since the machine is turned off, he or she may not have adequate resources for performing those activities.

### SUMMARY OF THE PRESENT INVENTION

The invention is advantageous in that it provides a behavior coaching system and a method thereof, which are capable of assisting a user to accomplish his or her preset objective through peer support and interactive displays.

Another advantage of the invention is to provide a behavior coaching system and a method thereof, wherein the coaching system can be implemented through a plurality of interactive devices, in which some or all of the interactive devices are portable so as to allow the user to access any training program or activities in anywhere or at anytime. The present invention also re-routes pushes and information along different interactive devices.

Another advantage of the invention is to provide a behavior coaching system and a method thereof, which are capable of supporting a wide range of objectives and means for accomplishing those training objectives. In other words, the present invention has a much wider application than conventional training systems because it does not run on a single machine for a single training program.

Another advantage of the invention is to provide a behavior coaching system and a method thereof, wherein peers may observe the training's progress of the user so as to provide suitable encouragement and support for the user for ultimately accomplishing the preset objectives set by the user.

Additional advantages and features of the invention will become apparent from the description which follows, and may be realized by means of the instrumentalities and combinations particular point out in the appended claims.

According to the present invention, the foregoing and other objects and advantages are attained by providing a method of coaching behavior by using at least one interactive device, comprising the steps of:

(a) creating a profile through the interactive device by a user, wherein the profile contains at least one type of information, wherein the profile is shown to other peers through a predetermined communication network;

(b) setting an objective in relation to the type of information in the interactive device;

(c) delivering a push notification to the user through the interactive device, wherein the push notification contains at least one request which is to be fulfilled by the user, wherein the request is preset by the user to achieve the objective;

(d) generating a corresponding change to the profile to be shown in the interactive device, wherein when the request is not fulfilled, a negative effect is generated in the profile as the change of the profile, and when the request is substantially fulfilled, a positive effect is generated in the profile as the change of the profile; and

(e) receiving feedback from the peers through the communication network in response to the change of the profile, wherein the feedback is received by the interactive device to provide support to the user so as to encourage the user to accomplish the objective.

In accordance with another aspect of the invention, the present invention provides a behavior coaching system, comprising:

a plurality of interactive devices linked together through a predetermined communication network, wherein each of the interactive devices comprises:

a central processing unit; and

a display, wherein the central processing unit is programmable by the user to create a profile which is shown by the display, wherein the profile contains at least one type of information, wherein the profile is also accessible to other peers through the predetermined communication network, wherein the central processing unit is also programmable to allow the user to set an objective in relation to the type of information, and is arranged to deliver a push notification to the user, wherein the push notification contains at least one request which is to be fulfilled by the user, and is preset by the user to achieve the objective, wherein the user interactive device is arranged to generate a corresponding change to the profile to be shown on the display, in such a manner that when the request is not fulfilled, a negative effect is generated in the profile as the change of the profile, and when the request is substantially fulfilled, a positive effect is generated in the profile as the change of the profile, wherein each of the interactive devices is arranged to receive feedback from other the interactive devices through the communication network in response to the change of the profile for providing support to the user so as to encourage the user to accomplish the preset objective.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a method of coaching behavior according to a preferred embodiment of the present invention.

FIG. 2 is a schematic diagram of a behavior coaching system according to the above preferred embodiment of the present invention.

FIG. 3 is a flow chart of a behavior coaching system and the method thereof to according to the above preferred embodiment of the present invention.

FIG. 4 is a schematic diagram of an application of the behavior coaching system and the method thereof according to the above preferred embodiment of the present invention.

### DETAILED DESCRIPTION OF THE PREFERRED EMBODIMENT

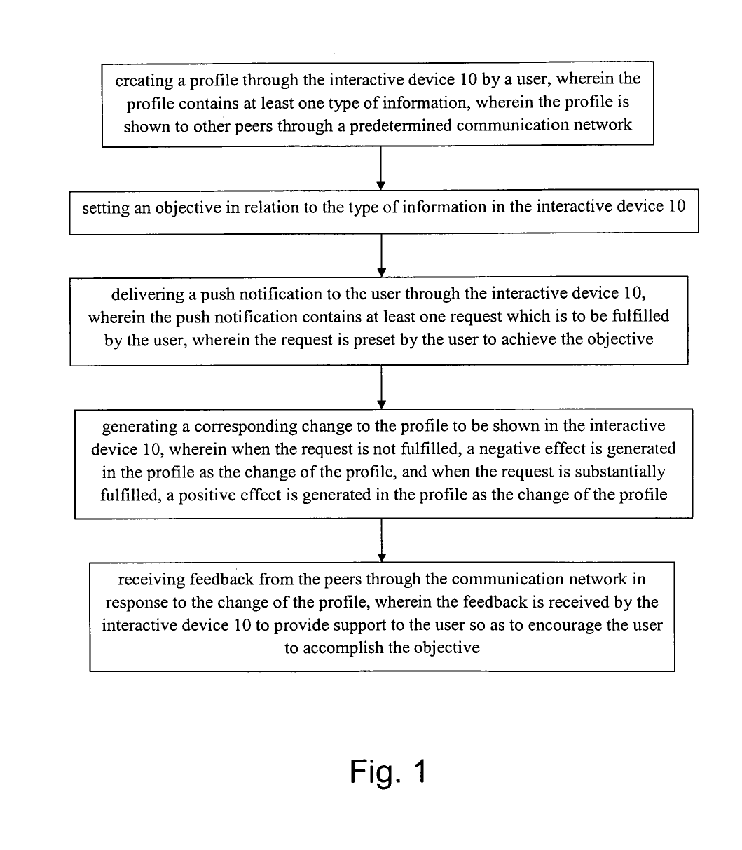

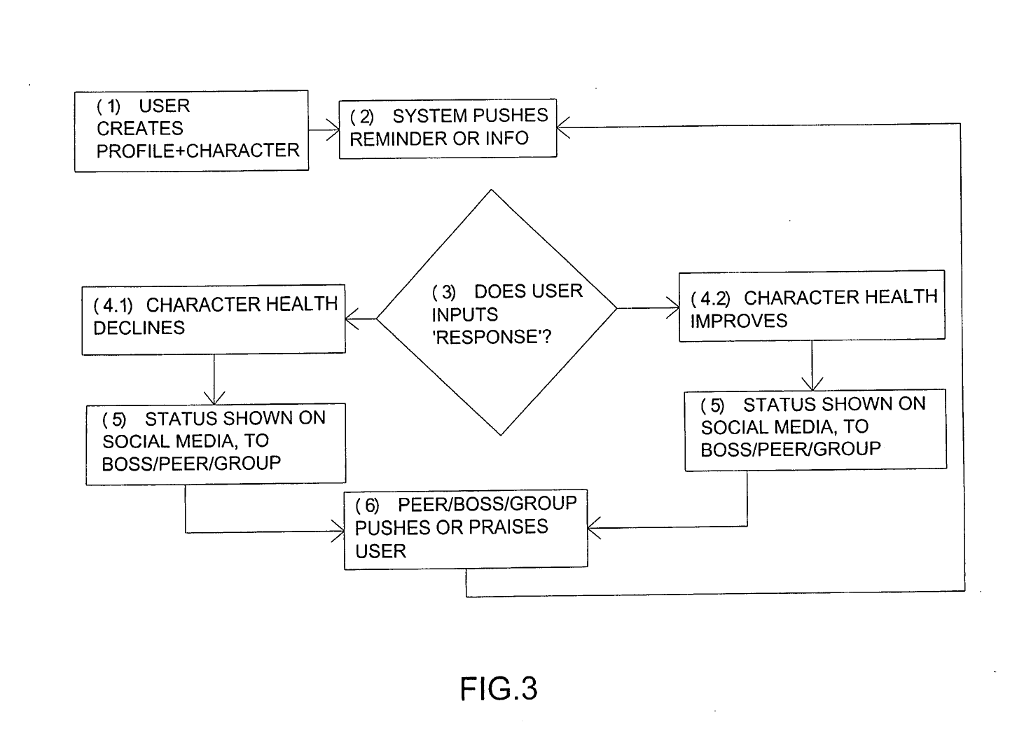

Referring to FIG. 1 to FIG. 4 of the drawings, a method of coaching behavior by using at least one interactive device 10 according to a preferred embodiment of the present invention is illustrated, in which the method comprises the steps of:

(a) creating a profile through the interactive device 10 by a user, wherein the profile contains at least one type of information, wherein the profile is shown to other peers through a predetermined communication network;

(b) setting an objective in relation to the type of information in the interactive device 10;

(c) delivering a push notification to the user through the interactive device 10, wherein the push notification contains at least one request which is to be fulfilled by the user, wherein the request is preset by the user to achieve the objective;

(d) generating a corresponding change to the profile to be shown in the interactive device 10, wherein when the request is not fulfilled, a negative effect is generated in the profile as the change of the profile, and when the request is substantially fulfilled, a positive effect is generated in the profile as the change of the profile; and

(e) receiving feedback from the peers through the communication network in response to the change of the profile, wherein the feedback is received by the interactive device 10 to provide support to the user so as to encourage the user to accomplish the objective.

According to the preferred embodiment of the present invention, each of the interactive devices 10 a central processing unit 11 and a display screen 12. The central processing unit 11 is pre-programmed to carry out the steps as mentioned above. The display screen 12 is arranged to show the profile to the user. The interactive devices 10 can be embodied as a desktop computer, a laptop computer, a tablet computer, a cellular phone, or other electronic devices having the central processing unit 11 and the display screen 12.

Step (a) comprises the steps of:

(a.1) generating a predetermined character as part of a profile of the user, wherein the character is shown on the display screen 12 by a graphical representation;

(a.2) selectively inputting parameters to the profile as the information, wherein the information may contain work information, project information, key milestones, sale goals, health information, prescription information, reminders, appointments, and the likes. The graphical representation is arranged to reflect the information inputted into the profile.

In step (b), the user may set up the objective which is to be accomplished by the user based on the information inputted to the profile. For example, the user may generate a fairly sick graphical representation of himself/herself and input prescription information and schedule to the profile. When the user follows the prescription schedule and makes the corresponding confirmation to the profile, the health of the character as represented by the graphical representation will improve gradually.

In step (c), the push notifications may be delivered to the user through a number of predetermined communication channels depending on the specific interactive devices 10 used. For example, the push notifications may be delivered in the form of emails, text messages, or through predetermined social media websites. Thus, when the interactive device 10 is embodied as a cellular phone, the push notifications may be delivered through SMS text messages. Likewise, when the interactive device 10 is embodied as a desktop computer, the push notifications may be delivered in the form of email messages.

Note that the user may possess a number of interactive devices 10 and synchronize those interactive devices 10 in such a manner that the user will receive the most up-to-date requirements for fulfilling the preset objective.

The method of coaching behavior further comprises a step, in between step (c) and step (d), of responding to the push notification, wherein the response contains a confirmation as to whether or not the request contained in the push notification has been performed. The user may set a time limit in which the response must be made. After that time limit, the interactive device 10 may regard the request as not having been fulfilled by the user.

In step (d), the positive effect and the negative effect are reflected on the user's profile and illustrated by the graphical representation shown on the display screen 12. For example, if the user fails to take the required medication, the character's health will degenerate so that the user and the peers group will observe the degenerating status of the user's health.

In step (e), peer groups will observe the status of the character created under the user's profile and may make the corresponding feedback. The feedback may contain encouraging messages or praising message as the status of the user's profile changes. For example, when the character's health degenerates, the message may contain encouragement. When the character's health improves, the message may contain praising language.

It is worth mentioning that the method of coaching behavior by using the interactive devices 10 may be supported by a server 20 in which coaching progress is periodically sent to the server 20 for particular coaching programs. Thus, the method comprises a step, before step (a), of setting up a coaching system server 20 which is linked to each of the interactive devices 10 and controls the coaching programs of each of the interactive devices 10. For example, the coaching progress or the request for push notification may be sent to the coaching system server 20 so that the push notifications are sent from the server 20 to the corresponding interactive devices 10.

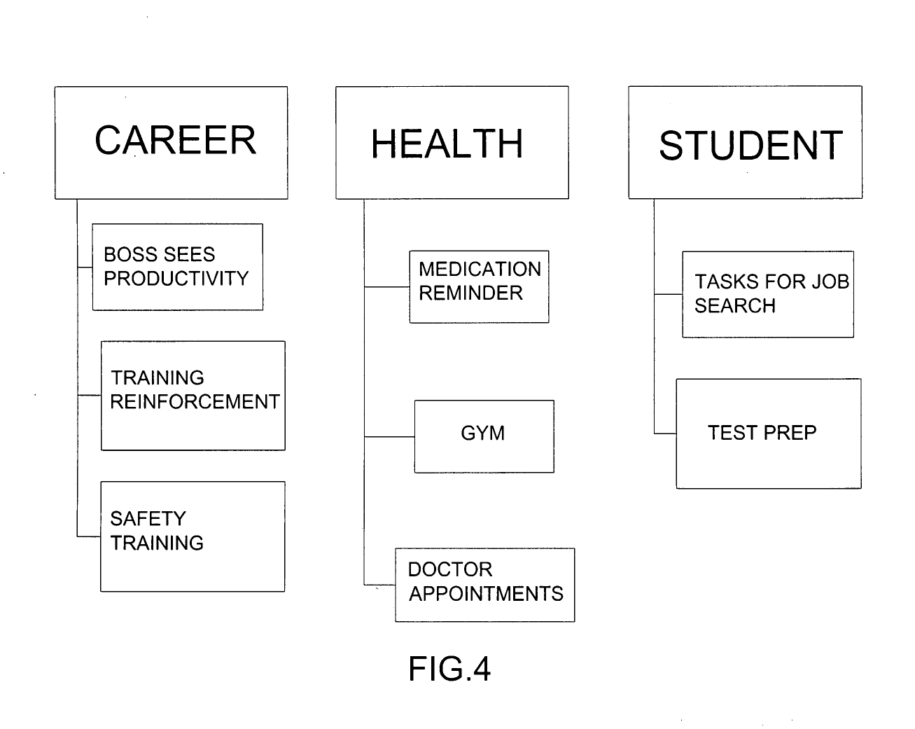

Moreover, the coaching method and system may perform many coaching functions, such as health coaching and career coaching. The objectives are freely set by the user of the present invention, as shown in FIG. 4 of the drawings.

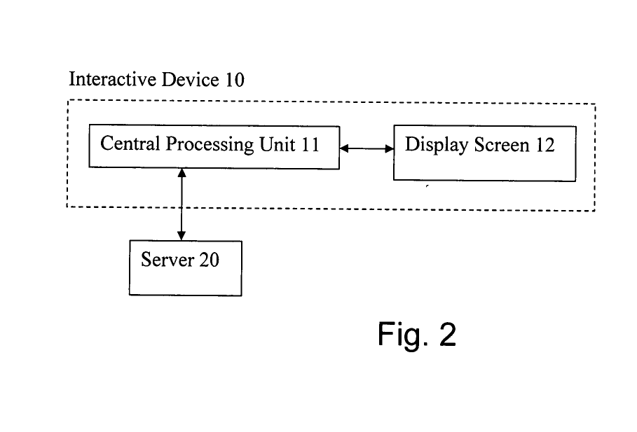

Referring to FIG. 2 of the drawings, the present invention also provides a behavior coaching system which comprises a plurality of interactive devices 10 each of which comprises a central process unit 11 and a display screen 12. The plurality of interactive devices 10 is linked together through a predetermined communication network.

The central processing unit 11 is programmable by the user to create a profile which is shown by the display screen 12, wherein the profile contains at least one type of information, wherein the profile is also accessible to other peers through the predetermined communication network. The central processing unit 11 is also programmable to allow the user to set an objective in relation to the type of information, and is arranged to deliver a push notification to the user, wherein the push notification contains at least one request which is to be fulfilled by the user, and is preset by the user to achieve the objective, wherein the user interactive device 10 is arranged to generate a corresponding change to the profile to be shown on the display screen 12, in such a manner that when the request is not fulfilled, a negative effect is generated in the profile as the change of the profile, and when the request is substantially fulfilled, a positive effect is generated in the profile as the change of the profile, wherein each of the interactive devices 10 is arranged to receive feedbacks from other the interactive devices through the communication network in response to the change of the profile for providing support to the user so as to encourage the user to accomplish the preset objective.

The behavior coaching system further comprises a server 20 in which coaching progress is periodically sent to the server for particular coaching programs. Each of the interactive devices 10 is linked to the server 20 which is arranged to control the coaching programs of each of the interactive devices 10. As mentioned above, the coaching progress or the request for push notification may be sent to the coaching system server 20 so that the push notifications are sent from the server 20 to the corresponding interactive devices 10.

The interactive device 10 further comprises a storage device 14 electrically connected to the central processing unit 11 for storing data to carry out the coaching process as mentioned above. The storage device 11 can be an external storage device or an internal device built-in in the interactive device 10.

The distinctive features of the behavior coaching system are as follows:

Repetition

The interactive device 10 provides push notification and reminders at a frequency of the user's free choice. For example, the interactive device 10 may remind a patient to take daily medications at prescribed times through a day. The interactive device 10 may also track an employee's adherence to compliance training at three to five times a week.

Representation

The profile generated by the interactive device 10 can be freely designed by the user and can take a variety of characters, such as a 3D animated character, a pet, or a sportsman. When the user complies with the preset request, the character created by the user grows. Conversely, when the user fails to comply with the request, the condition of the character worsens.

Public Sharing

The sharing of the status of the user's profile or the status of the character allows competition among peers (i.e. different users of the interactive devices 10). It also enables exchange of information among peers and encourages collaborative behavioral change because each member of the peer group has the role of monitoring the progress of others. The entire system also facilitates community support and encouragement. Moreover, the present invention promotes caring for others by providing peer support and feedback. For example, adults may take initiative to take care of their children or their relatives.

Subconscious Learning

By using the present invention, users learn to engage in behavioral change in a progressive manner. Rather than focusing on the content of the learning, users focus on the game-playing dynamics of e-behavior coach while learning in the process. The users may then effectively learn essentials in living healthier or working effectively. The present invention reduces the user's stress in accomplishing the preset objective because of the relaxed environment created by the character.

Fun

The present invention provides substantial fun to those who follow the requests and make progress to accomplish the preset objective. It also trains social skills by participating in a reward-based system. The rewards may make the entire system more engaging to users. For example, the interactive device may be preprogrammed to contain many levels of stories so that accomplishment of one story will unlock the next level. Moreover, successfully accomplishing an objective by one character may unlock other characters. Life savers (i.e. those users who have successfully encouraged others to accomplish objectives) may be rewarded by unlocking levels or characters.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of coaching behavior by using at least one interactive device, comprising the steps of:
(a) creating a profile through said interactive device by a user, wherein said profile contains at least one type of information, wherein said profile is shown to other peers through a predetermined communication network;
(b) setting an objective in relation to said type of information in said interactive device;
(c) delivering a push notification to said user through said interactive device, wherein said push notification contains at least one request which is to be fulfilled by said user, wherein said request is preset by said user to achieve said objective;
(d) generating a corresponding change to said profile to be shown in said interactive device, wherein when said request is not fulfilled, a negative effect is generated in said profile as said change of said profile, and when said request is substantially fulfilled, a positive effect is generated in said profile as said change of said profile; and
(e) receiving feedback from said peers through said communication network in response to said change of said profile, wherein said feedback is received by said interactive device to provide support to said user so as to encourage said user to accomplish said objective.

2. The method, as recited in claim 1, wherein each of said interactive devices comprises a central processing unit and a display screen, wherein said central processing unit is pre-programmed to carry out said step (a) to said step (e) while said display screen is arranged to show said profile to said user.

3. The method, as recited in claim 2, wherein said step (a) comprises said steps of:
(a.1) generating a predetermined character as part of a profile of said user, wherein a character is shown on said display screen by a graphical representation;
(a.2) selectively inputting parameters to said profile as said information, wherein said information, wherein said graphical representation is arranged to reflect said information inputted to said profile.

4. The method, as recited in claim 2, wherein in said step (b), said user is able to set up said objective which is to be accomplished by said user based on said information inputted to said profile.

5. The method, as recited in claim 3, wherein in said step (b), said user is able to set up said objective which is to be accomplished by said user based on said information inputted to said profile.

6. The method, as recited in claim 4, wherein in said step (c), said push notification is delivered to said user through a number of predetermined communication channels corresponding to said interactive device.

7. The method, as recited in claim 5, wherein in said step (c), said push notification is delivered to said user through a number of predetermined communication channels corresponding to said interactive device.

8. The method, as recited in claim 2, further comprising a step, in between said step (c) and said step (d), of responding to said push notification, wherein said response contains a confirmation as to whether or not said request contained in said push notification is performed.

9. The method, as recited in claim 5, further comprising a step, in between said step (c) and said step (d), of responding to said push notification, wherein said response contains a confirmation as to whether or not said request contained in said push notification is performed.

10. The method, as recited in claim 7, further comprising a step, in between said step (c) and said step (d), of responding to said push notification, wherein said response contains a confirmation as to whether or not said request contained in said push notification is performed.

11. The method, as recited in claim 8, further comprising a step, in between said step (c) and said step (d), of setting a time in which said response must be made, wherein after said time limit, said interactive device is arranged to regard said request is not fulfilled by said user.

12. The method, as recited in claim 9, further comprising a step, in between said step (c) and said step (d), of setting a time in which said response must be made, wherein after said time limit, said interactive device is arranged to regard said request is not fulfilled by said user.

13. The method, as recited in claim 10, further comprising a step, in between said step (c) and said step (d), of setting a time in which said response must be made, wherein after said time limit, said interactive device is arranged to regard said request is not fulfilled by said user.

14. The method, as recited in claim 13, wherein in said step (d), said positive effect and said negative effect are reflected on said user's profile and illustrated by said graphical representation shown on said display screen.

15. The method, as recited in claim 3, further comprising a step, before said step (a), of setting up a coaching system server which is linked to each of said interactive devices and controls said coaching programs of each of said interactive devices.

16. The method, as recited in claim 9, further comprising a step, before said step (a), of setting up a coaching system server which is linked to each of said interactive devices and controls said coaching programs of each of said interactive devices.

17. The method, as recited in claim 14, further comprising a step, before said step (a), of setting up a coaching system server which is linked to each of said interactive devices and controls said coaching programs of each of said interactive devices.

18. A behavior coaching system, comprising:
a plurality of interactive devices linked together through a predetermined communication network, wherein each of said interactive devices comprises:
a central processing unit; and
a display screen, wherein said central processing unit is programmable by said user to create a profile which is shown by said display screen, wherein said profile contains at least one type of information, wherein said profile is also accessible to other peers through said predetermined communication network, wherein said central processing unit is also programmable to allow said user to set an objective in relation to said type of information, and is arranged to deliver a push notification to said user, wherein said push notification contains at least one request which is to be fulfilled by said user, and is preset by said user to achieve said objective, wherein said user interactive device is arranged to generate a corresponding change to said profile to be shown on said display screen, in such a manner that when said request is not fulfilled, a negative effect is generated in said profile as said change of said profile, and when said request is substantially fulfilled, a positive effect is generated in said profile as said change of said profile, wherein each of said interactive devices is arranged to receive feedbacks from other said interactive devices through said communication network in response to said change of said profile for providing support to said user so as to encourage said user to accomplish said preset objective.

19. The behavior coaching system, as recited in claim 18, further comprising a server wherein each of said interactive devices is linked to said server which is arranged to control said operation of each of said interactive devices, wherein said push notification and feedback are sent from said server to said corresponding interactive devices.

20. The behavior coaching system, as recited in claim 19, further comprising a storage device electrically connected to the central processing unit for storing data to facilitate an operation of said interactive device.
